(19) United States
(12) Patent Application Publication
(10) Pub. No.: US 2016/0288357 A1
(43) Pub. Date: Oct. 6, 2016

(54) BANNER TRIMMING MACHINE

(71) Applicant: Martin Yale Industries, LLC, Wabash, IN (US)

(72) Inventors: Paul Wildey, Ft. Wayne, IN (US); Zachariah A. Frickel, North Manchester, IN (US)

(21) Appl. No.: 15/082,506

(22) Filed: Mar. 28, 2016

Related U.S. Application Data
(60) Provisional application No. 62/259,715, filed on Nov. 25, 2015.
(60) Provisional application No. 62/140,062, filed on Mar. 30, 2015.

(51) Int. Cl. B26D 7/14; B26D 5/10; B26D 7/01; B26D 7/26

(52) U.S. Cl. CPC B26D 7/14; B26D 7/2614; B26D 5/10; B26D 7/015

(57) ABSTRACT

Certain embodiments of the present disclosure describe a cutting device for trimming a banner. The cutting device includes a base assembly and a cutting assembly. The banner is placed over rollers attached to the frame, and two parallel blades pierce the banner at a gap between two of the rollers. A crank drives the rollers and advances the banner through the cutting device. As the banner is advanced, the banner is cut along parallel lines defined by the position of the blades.

### CROSS-REFERENCE TO RELATED APPLICATIONS

This application claims the benefit of U.S. Provisional Application No. 62/140,062 filed Mar. 30, 2015 and claims the benefit of U.S. Provisional Application No. 62/259,715 filed on Nov. 25, 2015, both of which are hereby incorporated by reference in their entirety.

### FIELD OF THE INVENTION

Aspects of the present invention deal with cutting machines, and in particular deal with machines for use in cutting banners.

### BACKGROUND OF THE INVENTION

Large-scale printing has a variety of applications, including making banners and signs that may be used by businesses for marketing or promotion. When a banner or sign is created, the printing process often creates margins around the printed area. The process may involve a printing machine which prints content on a banner material fed from a spool and then cuts it into a separated piece, for example as shown in FIG. 1. It is generally desirable to remove these margins before the banner or sign is displayed.

It is possible to manually remove the margins using scissors or another cutting tool such as a knife; however, banners are often made from material such as vinyl that may be difficult to cut. Additionally, due to the length of many of the signs or banners being cut, it can be difficult to maintain a straight or consistent cut when manually removing the margins. This results in nonparallel cuts that may cause a banner to look sloppy or unprofessional. Therefore, there is a need for a cutting device that is easy to operate and can remove margins from printed material with straight and consistent lines.

### SUMMARY OF THE INVENTION

Certain embodiments include a cutting device for trimming a flexible sheet of material such as a banner or a sign. Preferably, the cutting device trims straight margins on one or, in some instances, two sides of the banner or sign evenly and without distortion.

In some embodiments, the cutting device includes a base assembly and a cutting assembly. The cutting assembly may include a front roller, a back roller, and a support surface with a gap defined between the front roller and the support surface. At least one, but optionally two parallel blade assemblies including cutting blades are positioned above the support surface. The blade assembly is pivotable between a raised position and a lowered position. In the lowered position, the blade from the blade assembly is located in the gap between the support surface and the front roller.

To operate the cutting device, the leading edge of a flexible sheet material is inserted between the support surface and the blade assembly. The leading edge of the flexible sheet material is then secured to the front roller. The blade assembly is then positioned along the width of the flexible sheet material at a desired cut line and pivoted into its lowered position so that the blade from the blade assembly pierces the flexible sheet material.

The sheet material is then fed through the cutting assembly manually or using a powered arrangement. For example, a crank may be operated to drive the front roller and feed the sheet material through the cutting assembly. As the sheet material passes the blades, the unwanted side margin of the sheet material is removed. If there are two blade assemblies, both unwanted side margins of the sheet material may be removed. After the sheet material is fed through the cutting device, the sheet material may be removed from the front roller and any leading and trailing edges may be trimmed if desired.

In some embodiments, one or more blade assemblies may be slidably attached to a blade guide rod that is positioned above the support surface. The blade assemblies may be pivoted into the raised position and slid along the blade guide rod to a desired width along the sheet material at which the sheet material is to be cut. The blade assemblies may be pivoted into their lowered positions to expose blades that cut the sheet material.

In some embodiments, feed guides may be slidably positioned to extend over the front roller, the back roller and/or the support surface. A foot portion of the feed guides includes a gap through which a sheet material may be inserted to guide the sheet material as it is fed through the cutting assembly.

In other embodiments, the cutting assembly has a lower frame and an upper frame that is pivotally mounted and can be raised while loading a flexible sheet material into the cutting device. To load the flexible sheet material into the cutting device, the operator raises the upper frame and places the sheet material on a feed roller so it is arranged between two feed guides. The leading edge of the sheet material is placed over two rollers that are attached to the lower frame. The two rollers between the lower frame are positioned to have a small gap between them. The operator then closes the upper frame, causing two parallel blades connected to guide rods attached to the upper frame to pierce the sheet material in the gap between the two lower frame rollers. Two additional rollers attached to the upper frame contact the sheet material and assist to maintain constant tension on the sheet material at the gap between the two rollers on the lower frame.

The operator drives the rollers and advances the sheet material through the cutting device. For example, the rollers may be driven by a crank that is directly connected to one of the rollers. The other rollers are not directly driven by the crank, but rotate as the sheet material is fed through the cutting device. While the sheet material advances in the cutting device, the two parallel blades cut the sheet material along parallel lines defined by the position of the blades. Once the sheet material is completely fed through the cutting device, it may be removed and any leading and trailing edges may be trimmed if desired.

### BRIEF DESCRIPTION OF THE DRAWINGS

FIG. 1 illustrates a representative untrimmed plastic sheet material that may be inserted into a cutting device for cutting a plastic sheet material.

FIG. 2 is a perspective view of an embodiment of a cutting device used for trimming the untrimmed banner of FIG. 1.

FIG. 3 is a perspective view of a cutting assembly of the cutting device of FIG. 2 in an open position.

FIG. 4 is a perspective view of a cutting assembly of the cutting device of FIG. 2 in a closed position.

FIG. 5 is a perspective view of the cutting device of FIG. 2 with a plastic sheet material inserted for being cut.

FIG. 6 is a cross-sectional side view of the cutting device of FIG. 5.

FIG. 7 is a perspective view of an embodiment of a cutting device used for trimming the untrimmed plastic sheet material of FIG. 1.

FIG. 8 is a top view of the cutting device of FIG. 7.

FIG. 9 is a perspective view of a feed guide from the cutting device of FIG. 7.

FIG. 10 is a perspective view of a blade assembly from the cutting device of FIG. 7.

FIG. 11 is a cross-sectional side view of the cutting device of FIG. 7.

FIG. 12 is a flow chart for an embodiment of a method of trimming the margins of a flexible sheet material.

### DESCRIPTION OF PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

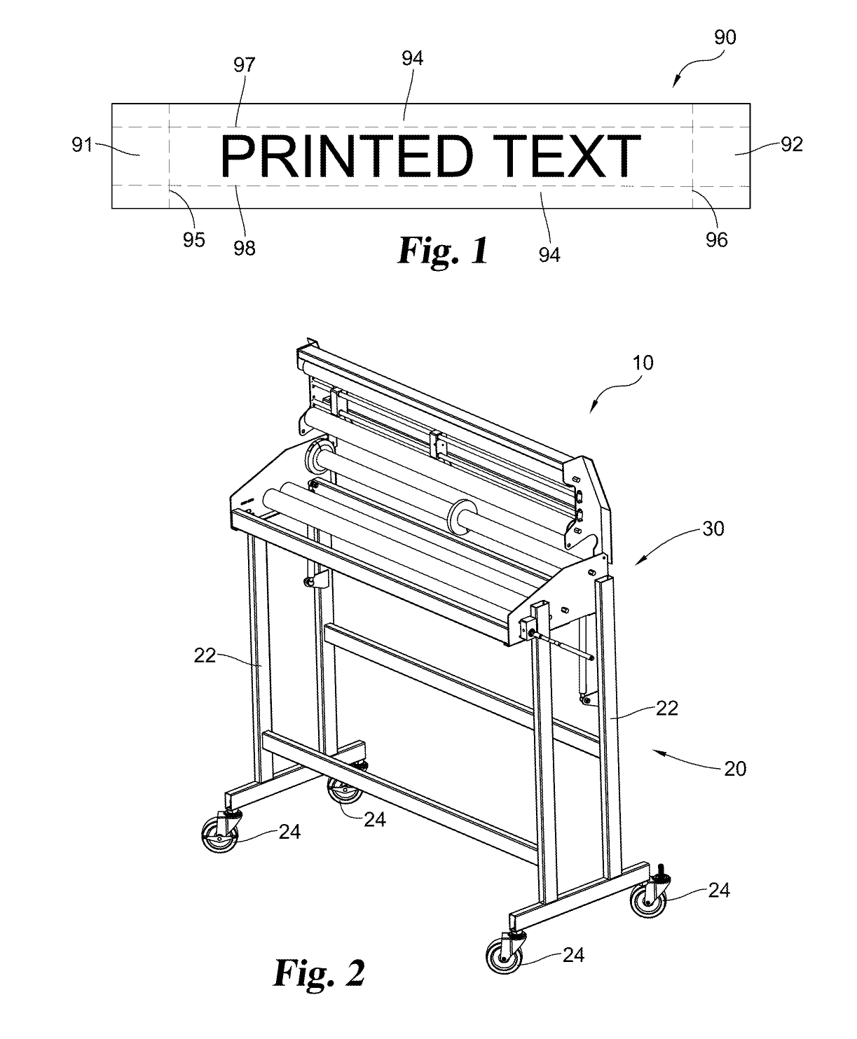

Certain embodiments shown in FIGS. 2-6 include a cutting device used for trimming margins from a flexible sheet material, such as a banner, shown in FIG. 1. The cutting device includes a base assembly and a cutting assembly. The cutting assembly includes a lower frame and an upper frame which is pivotally mounted to the lower frame. The upper and lower frames include a series of rollers. To load the banner to be trimmed into the device, an operator raises the upper frame and places the leading edge of the banner through the device with two edges of the banner aligned between two paper guides. The leading edge of the banner is placed over two rollers attached to the lower frame that have a small gap between them. The upper frame is then closed so that the banner is held between rollers on the lower frame and the upper frame. Two blades attached to the upper frame pierce the banner in the gap between the two lower frame rollers as the upper frame is closed. A crank is then turned to drive the rollers. As the banner is advanced through the machine, two parallel lines on the banner are cut by the two blades. Once the banner is completely fed through the machine, it is removed from the machine and the leading and trailing edges of the banner may be manually removed.

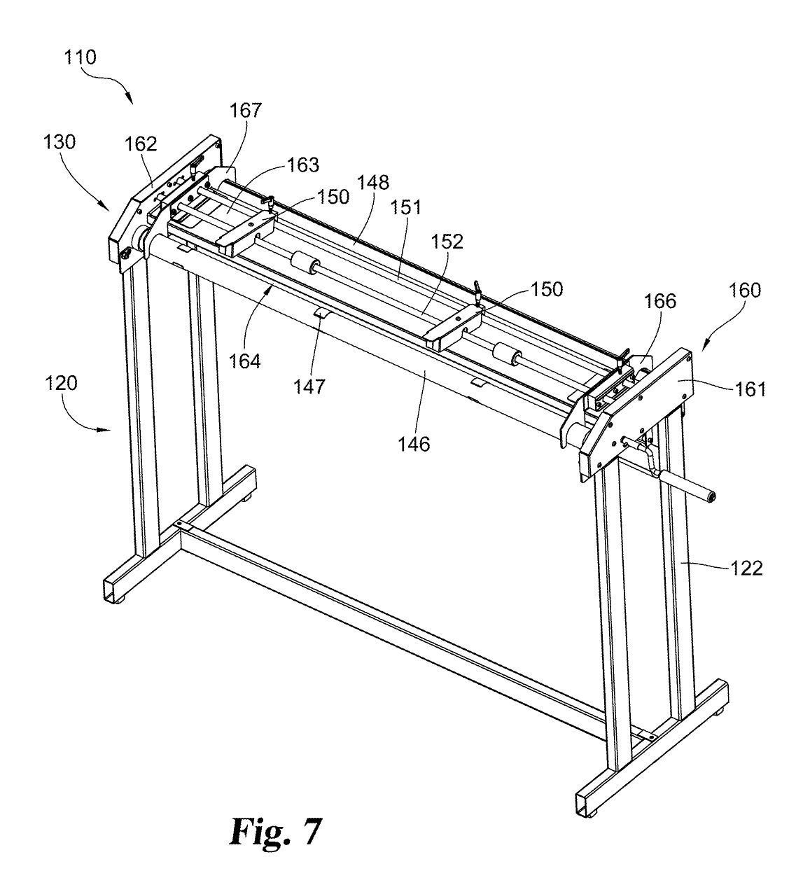

FIGS. 7-10 show an alternative embodiment of a cutting device for trimming margins from a banner. The cutting device includes a base assembly and a cutting assembly. The cutting assembly includes a front roller, a back roller, a support surface, and blade guide rods that extend between two sides of a frame. Optional feed guides are slidably positioned over the front roller, the back roller and the support surface. A foot portion of the feed guides includes a gap through which a banner may be inserted.

Parallel blade assemblies are pivotably and slidably mounted on the blade guide rods. The blade assemblies may be pivoted from a lowered position to a raised position. In the lowered position, a blade is exposed to cut a banner fed through the device. When in the raised position, the blade may be retracted into the housing of the blade assembly, and the blade assemblies may be slid along the blade guide rods to adjust the cutting position.

A portion of an uncut banner is held in a basket located underneath the back roller. The leading edge of the banner is laid over the top of the back roller and is threaded across the support surface, optionally through the gaps in the feed guides. The leading edge of the banner can be secured to the front roller, where it is held in place, for example, by clips placed around the front roller. The blade assemblies are positioned with respect to the banner where cuts are desired. The blade assemblies are then each pivoted into a lowered position so that the blades in the blade assemblies may pierce and/or cut the banner. A crank is turned to feed the banner through the cutting assembly, causing the blades to cut the banner and remove the unwanted margins.

FIG. 1 shows a flexible sheet material such as a sign or banner 90 on which an image or text has been printed. The printed sheet material or banner 90 may be made from vinyl, paper, or any other material onto which content may be printed. Often the material on which banner 90 is printed may be provided from a large spool of material, from which banner 90 is separated after printing. In many instances, the printed text or image does not span the entire length or width of the banner material, creating margins 94 and a leading edge 91 and trailing edge 92. It is often desired to remove this extra material. Removal may be performed by hand, but this may lead to uneven cuts that are not straight. Alternatively, a machine may be used to remove the margins and leading and trailing edges. This machine needs to be able to cut a banner 90 that has already been separated from a spool or larger piece of the flexible sheet material.

FIG. 2 illustrates a cutting device 10 which generally includes a base assembly 20 and a cutting assembly 30. Base assembly 20 includes one or more supports, such as legs 22, which support cutting assembly 30. Any attachment method may be used to attach legs 22 to base assembly 20. For example, legs 22 may be attached to cutting assembly 30 by welding or by screws.

In the embodiment shown, casters 24 are attached to the bottom of legs 22, allowing cutting device 10 to be rolled and easily moved. However, in other embodiments, base assembly 20 may not include casters 24 and instead includes another surface or device that allows legs 22 to stand upright.

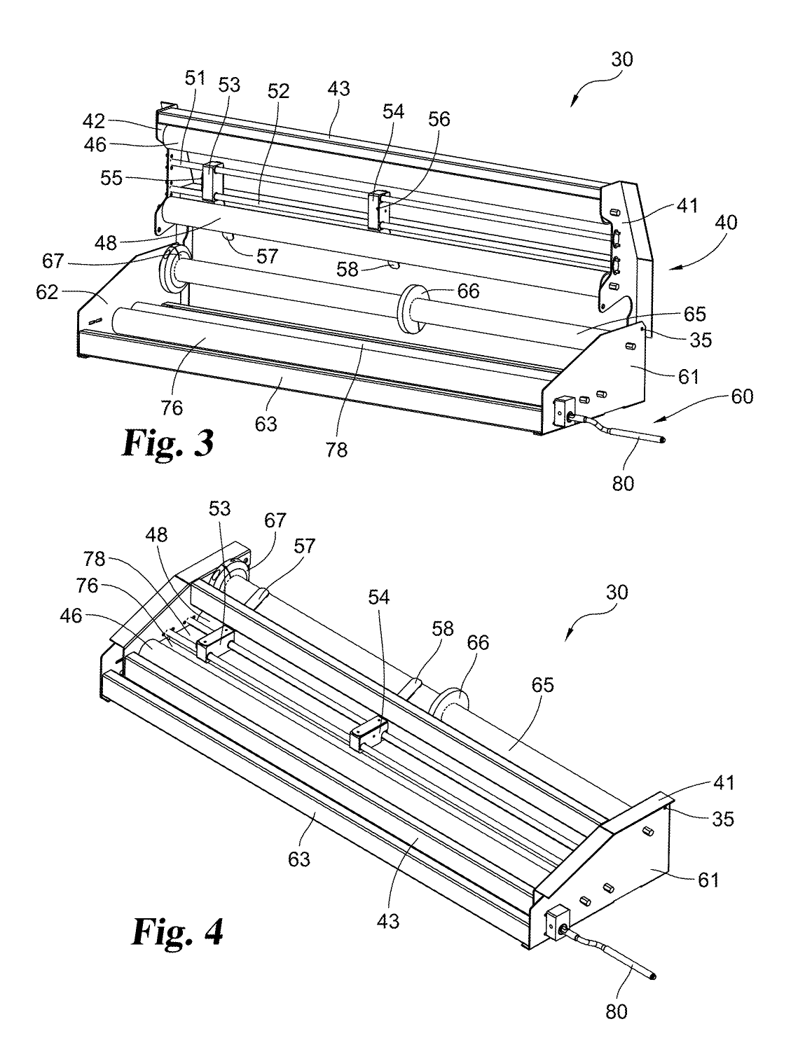

As shown in FIG. 3, cutting assembly 30 includes an upper frame 40 and a lower frame 60. Upper frame 40 is pivotably attached to lower frame 60 at attachment point 35 so that upper frame 40 may hinge about attachment point 35. Cutting assembly 30 is shown in the open position in FIG. 3. Cutting assembly 30 may be closed by rotating upper frame 40 so it covers lower frame 60 (see FIG. 4).

The structure of upper frame 40 is formed by upper side plates 41, 42 and one or more upper cross braces 43 that span the distance between side plates 41, 42. Upper frame 40 also includes an upper forward roller 46 and an upper rearward roller 48. Each roller 46, 48 extends the length of upper frame 40, between side plates 41, 42. One end of each of rollers 46, 48 is mounted to side plate 41 and the other end of each roller 46, 48 is mounted to side plate 42.

Rollers 46, 48 are attached to upper frame 40 so that a gap exists between rollers 46, 48. Blade guide rods 51, 52 extend between side plates 41, 42, with guide rods 51, 52 positioned in the gap between rollers 46, 48. Blade housings 53, 54 each have holes corresponding with the position of guide rods 51, 52 so housings 53, 54 may be slidably mounted on rods 51, 52. Blade housings 53, 54 are preferably attached to guide rods 51, 52 so that they do not rotate. Optionally, blade guides 57, 58 extend rearward from a respective housing 53, 54 (see FIG. 3). Each blade housing 53, 54 holds a razor blade 55, 56 that is used to pierce and cut a banner inserted into banner cutter device 10.

The position of razor blades 55, 56 along guide rods 51, 52 is adjustable by moving blade housings 53, 54, allowing an operator to change the position of blades 55, 56 to match with the trim lines to be cut on a banner. Each blade housing 53, 54 may be adjusted independently of the other blade housing 53, 54, so the operator may also change the location of each trim line. Once blades 55, 56 have been positioned correctly, the operator may selectively lock blade housings 53, 54 in a fixed location, so blades 55, 56 are stationary during cutting. Blade housings 53, 54 may be locked with a clamp, a set screw, or any other mechanism that provides sufficient friction to keep blade housings 53, 54 from moving on guide rods 51, 52. The adjustability of blades 55, 56 provides cutting device 10 with flexibility to accommodate different sizes of banners. In some embodiments, guide rods 51, 52 may include reference marks, adjustment notches, or similar indicator points so an operator can see or feel when blade housings 53, 54 are at pre-measured set points along guide rods 51, 52.

Blades 55, 56 may be easily removed and replaced within blade housings 53, 54, allowing replacement when a blade becomes dull. Similar to a construction knife, blades 55, 56 may be easily mounted into and removed from blade housings 53, 54. Additionally, blades 55, 56 may be optionally positioned behind a removable cover.

Some embodiments may include a fewer or a greater number of blade guides 53, 54 or blades 55, 56. For example, cutting device 10 may include only one blade or may include three or four blades. In some embodiments, blade guides may be added or removed from guide rods 51, 52 to adjust the number of lines the cutting machine 10 may cut.

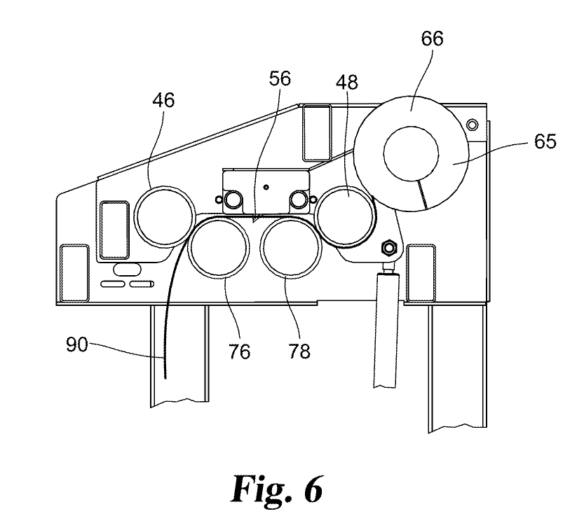

Lower frame 60 includes lower side plates 61, 62 and typically at least one lower cross brace 63. A feed roller 65 extends between side plates 61, 62. One feed guide 66 is slidably mounted to feed roller 65. Another feed guide 67 may be attached to feed roller 65 near side plate 62. Feed guide 67 may also be slidable along feed roller 65 or may be fixed. Lower rollers 76, 78 are attached between side plates 61, 62, forward of feed roller 65. Rollers 76, 78 are positioned on lower frame 60 to fit in the gap between upper rollers 46, 48 when upper frame 40 is closed on lower frame 60. Rollers 76, 78 are also spaced on lower frame 60 so there is a small gap between rollers 76, 78 (see FIG. 6). Rollers 46, 48, 76, 78 are preferably made from or coated in a material that inhibits slippage as a banner or other object rolls on rollers 46, 48, 76, 78. For example, rollers 46, 48, 76, 78 may be coated in polyurethane or a similar material to allow banner 90 to roll smoothly over rollers 46, 48, 76, 78.

A driving mechanism, such as crank 80, is attached to side plate 61 and linked to roller 76 so that rotation of crank 80 causes roller 76 to rotate. In other embodiments, crank 80 may be attached to side plate 62 or may be directly connected to a roller other than roller 76. In some embodiments, crank 80 may be manually operated. Alternatively, a powered arrangement can be used, for example, an electric motor may be used to drive roller 76 instead of a manually operated crank. The electric motor drives one of the rollers and the operator controls the electric motor using a control, for example, a control accessible on one of the side plates of the cutting assembly. In some embodiments, a speed limiter may be applied to the lower rearward roller 78 to prevent roller 78 from moving faster than the lower forward roller 76.

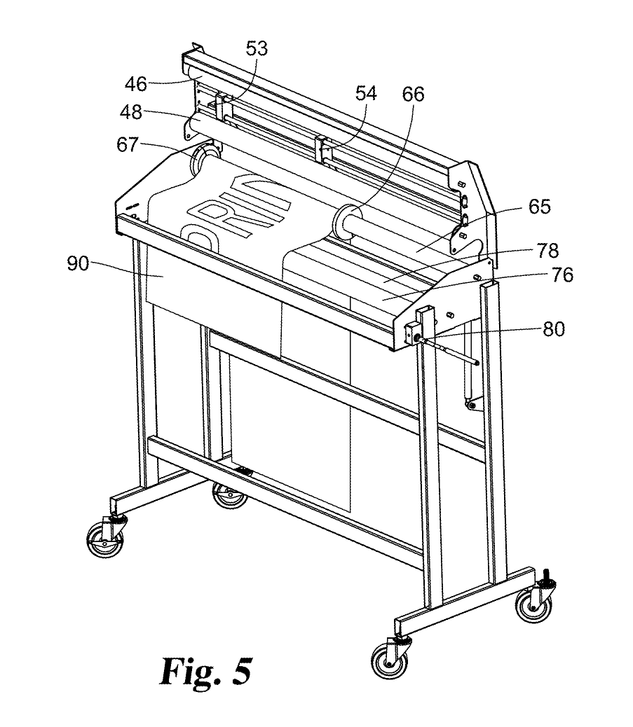

Banner 90 includes printed text surrounded by a leading edge 91, a trailing edge 92, and side margins 94 (see FIG. 1). The leading edge 91 of banner 90 is draped over rollers 76, 78 (see FIG. 5). The trailing edge 92 hangs from the rear of feed roller 65, or is otherwise fed to feed roller 65. In many applications, it is desirable to reduce the size of leading edge 91, trailing edge 92, and side margins 94 so there is less blank space around the printed text. Side margins 94 correspond to the top and bottom of the completed banner and may be removed by cutting along cut lines 97, 98. Leading edge 91 may be removed by cutting along cut line 95. Trailing edge 92 may be trimmed by cutting along cut line 96. The position of cut lines 95, 96, 97, 98 may vary depending on the final desired dimensions of banner 90 and the amount of blank space desired around the printed portion of the banner. The position of cut lines 95, 96 determines the length of banner 90, while the position of cut lines 97, 98 determines the height of banner 90.

Typically, the flexible sheet material may be any type of object that needs to be trimmed and may be constructed from a variety of materials. For example, the flexible sheet material could be a vinyl banner, or the flexible sheet material could be a paper or cardboard sign, poster, or streamer. It is not necessary for the flexible sheet material to be attached to a spool or a feeding device separate from cutting device 10.

To use cutting device 10, an operator raises upper frame 40. The operator places a banner 90 over feed roller 65 so side edges 99 of banner 90 are aligned between feed guides 66, 67. Once banner 90 has been positioned on rollers 76, 78, the operator slides feed guide 66 along feed roller 65 until it contacts and is flush with the edge of banner 90. The operator adjusts the position of blade housings 53, 54 by sliding housings 53, 54 along guide rods 51, 52. Blade housings 53, 54 are positioned to align razor blades 55, 56 at the desired cutting locations 97, 98 along banner 90 to remove any margins that may exist on banner 90. In some embodiments, a positioning aid such as a ruler or an indexing aid may be included on cutting assembly 30 that allows blades 55, 56 to be precisely placed in desired locations, for example as referenced by blade guides 57, 58.

Once blades 55, 56 are aligned as desired, the operator closes upper frame 40 onto lower frame 60. Upon closing, rollers 46, 48 contact banner 90, allowing banner 90 to remain in tension over rollers 76, 78. Also, when upper frame is closed on lower frame 60, blades 55, 56 preferably puncture or cut banner 90 in the gap between roller 76 and roller 78 (see FIG. 6). The operator turns crank 80, driving roller 76 and causing roller 76 to rotate. The rotation of roller 76 feeds banner 90 through cutting assembly 30, and in turn, rollers 46, 48, 78 rotate and assist to feed banner 90 through cutting assembly 10.

As banner 90 moves through cutting assembly 30, razor blades 55, 56 cut through banner 90 along parallel cut lines 97, 98 defined by the position of blades 55, 56. The cut lines 97, 98 could, for example, be aligned with the margins of printing on banner 90, and remove the margins. The four rollers 46, 48, 76, 78 preferably provide constant and consistent tension on banner 90, producing a flat cutting surface through which blades 55, 56 may provide a precise cut. The tension provided by rollers 46, 48, 76, 78 evenly feeds banner 90 through cutting assembly 30 avoiding binding or misalignment of banner 90.

Cutting device 10 may operate with a banner 90 that is not attached to a spool or a feeding device due to the tension applied to banner 90 by rollers 46, 48, 76, 78 and because the feed roller ensures that banner 90 is straight as it contacts lower rollers 76, 78 and is cut by blades 55, 56. This feature reduces the size of cutting device 10 and allows operation after banner 90 has been printed and separated. A banner 90 may be easily loaded into and removed from cutting device by a single operator.

Once banner 90 is completely fed through cutting assembly 30, banner 90 may be removed from cutting device 10. If desired, the operator may trim leading edge 91 by cutting along cut line 95 and trim trailing edge 92 along cut line 96.

In some embodiments, a cover may be included that extends over and covers the top of upper frame 40. The cover protects an operator from getting hands or loose clothing caught in the moving rollers, protecting these items from being cut by blades 55, 56. In some other embodiments, base assembly 20 may include a banner catch such as a basket that prevents the portions of banner 90 that have already been cut from piling on the floor in front of the cutting device 10 and wrinkling.

In some embodiments, cutting assembly 30 is dimensioned to accommodate a banner 90 that has a width that is up to approximately 42 inches. Other embodiments may be dimensioned to accommodate smaller or greater widths. Feed guides 66, 67 and blade housings 53, 54 are preferably dimensioned to allow cutting assembly 30 to cut a banner 90 with a minimum width of approximately 4 inches. However, other embodiments may have a minimum vinyl width larger than 4 inches.

FIGS. 7-8 illustrate an alternate embodiment of a cutting device 110 for cutting a flexible sheet material. Cutting device 110 generally includes a base assembly 120 and a cutting assembly 130. Base assembly may include legs 122 that support cutting assembly 130. Any attachment method may be used, for example legs 122 may be attached to cutting assembly 130 by welding or by screws. Alternatively, any suitable bases may be used for cutting device 110. Additionally, in other embodiments, cutting assembly 120 may be positioned on a work surface such as a table or a counter.

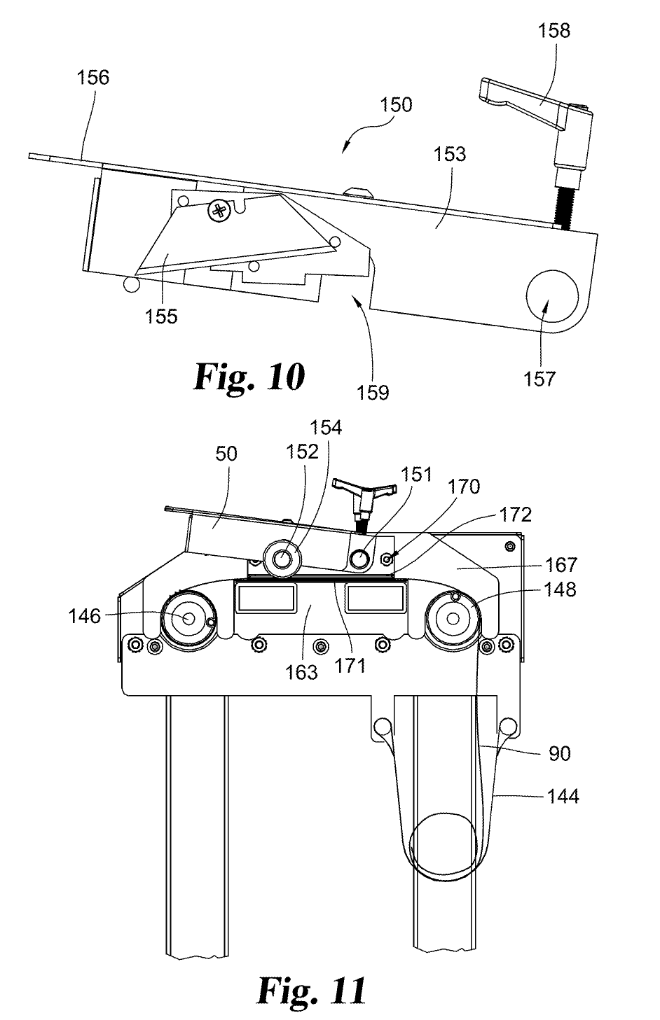

Cutting assembly 130 has a frame 160 that includes side plates 161, 162. A front roller 146 and a back roller 148 extend between plates 161, 162 and are attached to plates 161, 162 so that each roller 146, 148 may rotate. One or more clips 147 may be attached to front roller 146 to serve as a take-up roller. A support section 163 extends between plates 161, 162 and is located between front roller 146 and back roller 148. Support section 163 includes an upper flat surface that is perpendicular to a cutting device, such as a blade 155 (see FIG. 10). This upper flat surface of support section 163 supports a flexible sheet material while the flexible sheet material is being cut and may be made of a self-healing or scratch resistant material to reduce damage caused by or to the blade 155 if a blade contacts support section 163. A gap 164 is defined between support section 163 and front roller 146.

Two blade guide rods 151, 152 are located above support section 163 and are also attached to and extend between plates 161, 162. An optional basket 144 (see FIG. 11) is attached to the rear of frame 160 between plates 161, 162 so that basket 144 hangs underneath back roller 148.

An optional feed guide 166 positioned near side plate 161 is slidably attached to cutting assembly 130. An additional optional feed guide 167 positioned near side plate 162 is also slidably attached to cutting assembly 130. Feed guides 166, 167 may extend over front roller 146, back roller 148, and support section 163. Guide rods 151, 152 extend through openings in feed guides 166, 167 and support feed guides 166, 167.

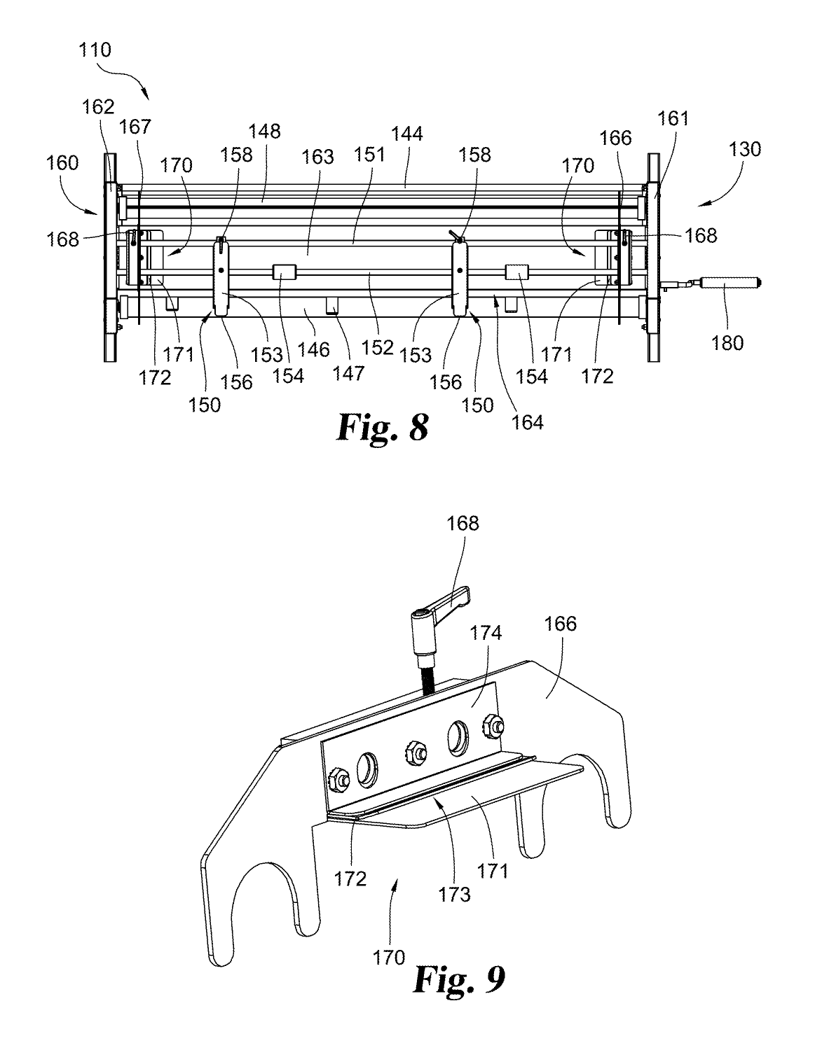

As shown in FIG. 9, each feed guide 166, 167 includes a foot portion 170 that extends laterally inward a short distance from a respective feed guide 166, 167. Each foot portion 170 includes a bottom shelf 171 and a top shelf 172 that are parallel to and spaced apart from each other to form a gap 173 between bottom shelf 171 and top shelf 172. Gap 173 between bottom shelf 171 and top shelf 172 is parallel to the upper flat surface of support section 163 and may be large enough to be able to fit the thickness of a banner 90 into gap 173. A bracket 174 connects each foot portion 170 to a respective feed guide 166, 167.

Feed guides 166, 167 are slidably adjustable within the width of cutting assembly 130 to allow flexible sheet materials of different widths to be inserted through each of the foot portions 170 of guides 166, 167. A clamp 168 on each of the feed guides 166, 167 may be selectively tightened to keep feed guides 166, 167 from sliding along cutting assembly 130 when feed guides 166, 167 are positioned at a desired position and distance from each either. Clamp 168 may be a bolt clamp, a compression clamp, or any other mechanism that can be secured to keep feed guide 166 or 167 from unintended sliding. In some embodiments, only one of the feed guides 166, 167 may be slidable along cutting assembly 130 while the other feed guide 166, 167 is stationary.

Two blade assemblies 150 are slidably attached to blade guide rods 151, 152 in between feed guides 166, 167. The positions and distance between blade assemblies 150 may be changed by sliding blade assemblies 150 along blade rods 151, 152 to cut a banner 90 at a desired width. As shown in FIG. 10, each blade assembly 150 includes a housing 153 (made transparent in FIG. 10 to allow a view of the components inside) that defines an opening 157 which guide rod 151 passes through. Blade housing 153 also defines a groove or slot 159 that is sized and positioned to allow guide rod 152 to be inserted into groove 159.

Blade assembly 150 is pivotably mounted to guide rod 151, so that blade assembly 150 may be moved between a lowered position and a raised position. Blade assembly 150 may be pivoted on guide rod 151 between the lowered and raised position by pushing downward on or lifting a tongue 156 that extends from the front of housing 153. In some embodiments, tongue 156 may be replaced with an alternative mechanism that allows blade assembly 150 to be lifted or lowered. For example, a button may be positioned on the front of blade assembly 150 and pushing the button may cause blade assembly 150 to pivot upward into the raised position.

A selective locking mechanism can be used to hold blade assembly 150 in the lowered position with blade 155 exposed. When blade assembly 150 is moved into the lowered position, guide rod 152 is inserted into groove 159 of blade housing 153. Also, a blade 155 that is attached inside the blade housing 153 is exposed so that the sharpened portion of blade 155 extends outside of the housing 153. The sharpened portion, namely the tip of blade 155 is positioned in gap 164 between support surface 163 and front roller 146, so that when a banner is in cutting assembly 130, the blade 155 will contact and extend through the thickness of the banner when the blade assembly 150 is in the lowered position.

When blade assembly 150 is unlocked and pivoted to a raised position, blade assembly 150 pivots so that guide rod 152 is no longer positioned in groove 159. Optionally yet preferably, in the raised position, blade 155 retracts into housing 153. Blade assembly 150 may be slid along guide rod 151 to a desired position and/or the banner can be positioned in cutting assembly 130 without damaging the banner.

In some embodiments, a safety mechanism may be included in blade assembly 150 that retracts blade 155 into blade housing 153 when blade assembly 150 is raised. Blade 155 is then extended to an exposed position when blade assembly 150 is pivoted to a lowered position so that blade 155 may cut through a banner. As an example, blade 155 may be pivotably mounted within housing 153, for example on a lever arm. A spring may bias blade 155 so that the sharpened edge of blade 155 is retracted within housing 153. When housing 153 is pivoted into its lowered position, guide rod 152 is inserted into groove 159 and may apply force to the blade or lever arm which overcomes the biasing force, causing blade 155 to pivot so the sharpened edge of blade 155 extends outside of housing 153. When guide rod 152 is disengaged from groove 159, blade 155 retracts.

A clamp 158 may be located adjacent opening 157. Clamp 158 may be tightened to secure blade assembly 150 and to not allow blade assembly 150 to slide along guide rod 151 once blade assembly 150 has been positioned at its desired location. Also, when clamp 158 is tightened, blade assembly 150 may be restricted from pivoting to keep blade assembly 150 in its lowered position while a banner is being cut.

Cutting assembly 130 may also include a driving mechanism, such as crank 180, that extends from one of the side plates 161, 162. Crank 180 may be operationally connected to front roller 146 so that turning crank 180 causes front roller 146 to turn. In some embodiments, crank 180 may be directly connected to front roller 146, or crank 180 may include one or more gears housed within side plate 161 or 162 that drive front roller 146. In some embodiments, these gears may be designed so that there is a 1:1 gear ratio between the rotation of crank 180 and the rotation of front roller 146. In other embodiments, there may be any desired gear ratio. Also, alternative force transmitting mechanisms such as chains or belts may be used.

In some embodiments, crank 180 may be manually operated. Alternatively, an electric motor or another powered mechanism may be used to drive front roller 146 instead of a manually operated crank. The electric motor drives front roller 146 and the operator controls the electric motor using a control, for example, a control accessible on one of the side plates of the cutting assembly.

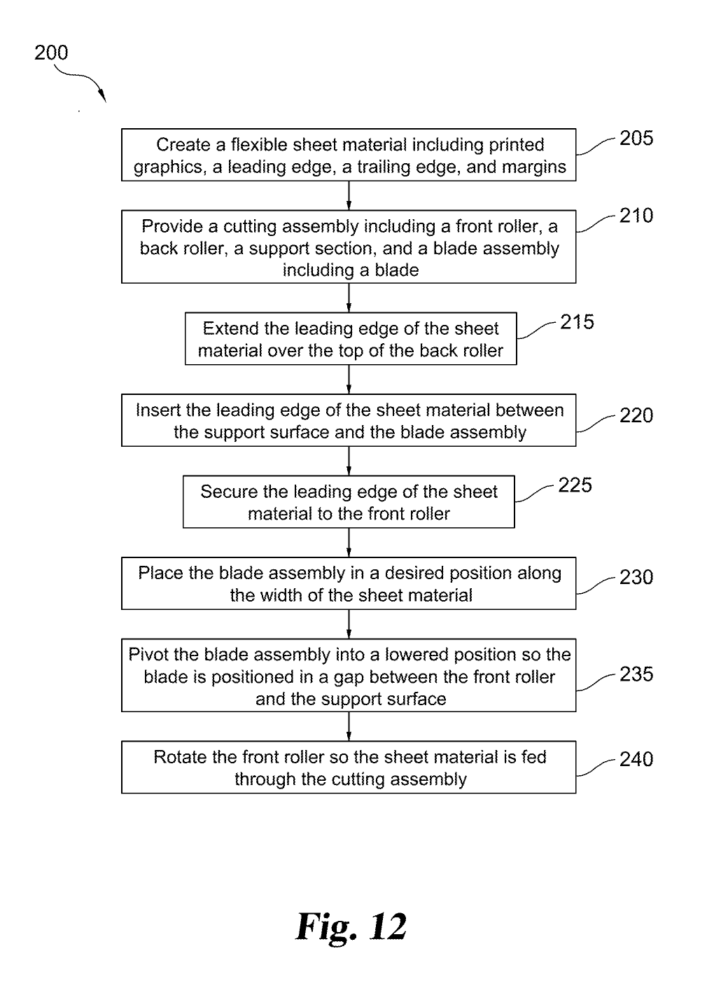

FIG. 12 is a flowchart 200 for an embodiment of a method of trimming the margins of a flexible sheet material. In some embodiments, a flexible sheet material, such as a banner 90, may be initially and separately created 205 and include printed graphics, a leading edge 91, a trailing edge 92 and margins 94. The banner 90 may include excess material or unprinted portions that may be desired to be removed. A cutting assembly including a front roller, a back roller, a support section, and a blade, such as the assembly shown in FIGS. 7-11, may be provided 210 to trim some of the unwanted margins of the flexible sheet material.

As an optional feature, banner 90 is inserted into a basket 144 that is attached to cutting assembly 130. Banner 90 may be precut to a desired length, or banner 90 may be a pre-rolled length of material that is to be cut to a desired length after being fed through cutting assembly 130. As shown in FIG. 11, the leading edge 91 of banner 90 is extended 215 upward from basket 144 and laid over the top of back roller 148. The leading edge 91 is then inserted 220 between support surface 163 and blade assembly 150, while blade assembly 150 is positioned in its raised position. In some embodiments, blade assembly 150 is attached to guide rods 151, 152, so that leading edge 91 is fed underneath guide rods 151, 152.

Leading edge 91 of banner 90 is then secured 225 to front roller 146 so that banner 90 can be pulled and will wrap around front roller 146 as front roller 146 turns. As an example, C-shaped clips 147 may be placed on front roller 146 and on top of leading edge 91 to secure leading edge 91 to front roller 146 and to allow banner 90 to wrap around front roller 146 as banner 90 is cut.

Once leading edge 91 of banner 90 has been secured to front roller 146, blade assembly 150 is placed 230 in a desired position along the width of the sheet material. This desired position could be along one of the cut lines 97, 98 to remove an unwanted margin 94. In some embodiments, blade assembly 150 is slid along guide rods 151, 152 generally while in the raised position to a cut line 97 or 98 on banner 90. Other embodiments may include multiple blade assemblies 150 and each blade assembly 150 may be moved to a respective cut line 97, 98.

Once blade assembly 150 is placed at a desired position, blade assembly 150 is pivoted 235 into its lowered position so that blade 155 pierces banner 90 at a point on a respective cut line 97, 98 and blade assembly 150 is then locked in place using clamp 158. If cutting assembly 130 has multiple blade assemblies 150, each of the blade assemblies 150 is pivoted into a lowered position so that the respective blades 155 pierce the banner 90 at cut lines 97, 98.

Next, front roller 146 is rotated 240 causing banner 90 to be pulled or drawn forward, applying tension to banner 90 against the resistance of the blades 155 and allowing a cutting action. In some embodiments, front roller 146 may be rotated using a driving mechanism, such as a crank 180. As front roller 146 rotates, banner 90 is unwound from basket 144 and fed through cutting assembly 130 from the rear to the front. As banner 90 moves through cutting assembly 130, blade 155 cuts through banner 90 along a respective cut line 97 or 98 to remove a margin 94. If cutting assembly 130 includes multiple blades, blades 155 cut through banner along parallel cut lines 97, 98, removing both margins 94. The cut portion of banner 90 is then taken up by being wrapped around front roller 146. The securement of the cut portion of banner 90 to front roller 146 maintains tension on the uncut portion of banner 90 to keep banner 90 taut as it passes through blades 155.

Once banner 90 is fed through cutting assembly 130 a desired length, banner 90 may be removed from cutting device 110. If desired, the operator may trim leading edge 91 of banner 90 by cutting along cut line 95 and trim trailing edge 92 of banner 90 along cut line 96. Trimming the leading edge 91 and trailing edge 92 may be done manually or by an automated method.

In some embodiments, feed guides 166, 167 may be used to help keep banner 90 aligned as it is fed through cutting assembly 130. Feed guides 166, 167 may be slid along cutting assembly 130 and positioned so that the distance between feed guides 166, 167 is substantially the same as the width of the banner 90. As part of the feeding process, banner 90 is inserted through gap 173 between bottom shelf 171 and top shelf 172 of the foot portions 170 of feed guides 167, 168.

In other embodiments, banner 90 is laid over back roller 48, fed underneath guide rods 151, 152 so that banner 90 rests on support section 163, and leading edge 91 is secured to front roller 46. Then, feed guides 166, 167 are slid along cutting assembly 130 until the edges of banner 90 are inserted into gap 173 between bottom shelf 171 and top shelf 172. Banner 90 is then fed through cutting assembly 130 to trim unwanted margins.

By inserting banner 90 through gap 173, foot portions 170 help keep banner 90 flat and aligned while being cut by blades 155, helping to provide a clean, straight cut. Additionally, guide rollers 154 positioned around guide rod 151 or 152 may help maintain tension on banner 90 and help keep banner 90 flat as it passes through blades 155.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method of cutting a flexible sheet material including a width, a length, a leading edge and a trailing edge, comprising the acts of:
providing a cutting assembly, wherein said cutting assembly includes a rotatable front roller and a rotatable back roller, a support section including an upper surface, and a first blade assembly including a blade pivotably positioned above a gap defined between said front roller and said support section;
inserting the leading edge of the flexible sheet material between said support surface and said blade assembly, so that the sheet material is positioned underneath said blade and over the upper surface of said support section;
securing the leading edge of the sheet material to said front roller;
placing said first blade assembly while said first blade assembly is in a raised position in a desired position along the width of the sheet material;
pivoting said first blade assembly into a lowered position so that at least a portion of the blade of said first blade assembly is positioned in said gap between said front roller and said support section, so that said blade pierces the sheet material; and,
operating a driving mechanism on the cutting assembly that causes said front roller to rotate, so that the sheet material is fed through the cutting assembly, causing said blade to cut the sheet material.

2. The method of claim 1, comprising the act of:
holding said first blade assembly in said lowered position while operating said driving mechanism.

3. The method of claim 1, wherein the trailing edge of said sheet material is held in a basket positioned below said back roller while the sheet material is fed through said cutting assembly.

4. The method of claim 1, wherein said cutting assembly includes a second blade assembly.

5. The method of claim 4, comprising the acts of:
placing said second blade assembly while said second blade assembly is in a raised position to a desired position along the width of said sheet material; and,
pivoting said second blade assembly into a lowered position so that the blade of said second blade assembly pierces the sheet material.

6. The method of claim 1, wherein the sheet material wraps around said front roller as said driving mechanism is operated.

7. The method of claim 1, comprising the acts of:
positioning a slidable feed guide adjacent to an edge of the sheet material, wherein said feed guide includes a foot portion including a bottom shelf and a top shelf extending substantially parallel to said bottom shelf to define a gap between said top shelf and said bottom shelf;
inserting the sheet material into said gap between said top shelf and said bottom shelf of said feed guide.

8. The method of claim 1, comprising the acts of:
removing the flexible sheet material from said front roller after the length of the flexible sheet material has been fed through said cutting assembly;
trimming the leading edge from the flexible sheet material;
trimming the trailing edge from the flexible sheet material.

9. A method of forming a flexible sheet material including a width and a length, comprising the acts of:
creating a flexible sheet material including a portion with printed graphics, a leading edge, and a trailing edge, wherein said flexible sheet of material includes margin portions that are to be removed;
placing the flexible sheet material over the back roller and the support section of said cutting assembly;
engaging the leading edge with the front roller of said cutting assembly;
placing the first blade assembly at a first width along a margin of the flexible sheet material;
pivoting the first blade assembly into a lowered position so that the blade of the first blade assembly cuts the flexible sheet material; and,
feeding the flexible sheet material through said cutting assembly causing the blade to cut the flexible sheet material and remove a margin.

10. The method of claim 9, comprising the act of:
inserting a portion of the flexible sheet material including the trailing edge into a basket attached to a cutting assembly, wherein said cutting assembly includes a rotatable front roller and a rotatable back roller, a support section including an upper surface, and a first blade assembly including a pivotable blade assembly;

11. The method of claim 9, comprising the acts of:
placing a second blade assembly at a second width along a margin of the flexible sheet material; and,
pivoting the second blade assembly into a lowered position so that the blade of the second blade assembly cuts the flexible sheet material.

12. An assembly for cutting a flexible sheet material comprising:
a rotatable back roller for supporting a flexible sheet material;
a rotatable front roller parallel to said back roller and arranged to support and pull the sheet material forward;
a support section located between said front roller and said back roller, wherein said support section includes an upper surface for supporting the sheet material;
a gap defined between said front roller and said support section;
at least one blade assembly positioned above said support section, wherein said blade assembly includes a blade; and,
wherein said blade assembly is pivotably movable between a raised position and a lowered position and when said blade assembly is in said lowered position, a portion of said blade is positioned in said gap between said support section and said front roller such that said blade cuts the sheet material as the sheet material is pulled forward.

13. The cutting assembly of claim 12, comprising:
a driving mechanism attached to said front roller, wherein said driving mechanism may be operated to cause said front roller to rotate.

14. The cutting assembly of claim 12, comprising:
a basket attached to said frame, wherein said basket holds a supply of the sheet material to be fed to the back roller.

15. The cutting assembly of claim 12, wherein said blade is located within a housing, and at least a portion of said blade extends outside of said housing when said blade assembly is in said lowered position.

16. The cutting assembly of claim 15, wherein said blade retracts within said housing when said blade assembly is pivoted from said lowered position to said raised position.

17. The cutting assembly of claim 12, wherein said blade assembly includes a clamping mechanism that may be tightened to prevent said blade assembly from sliding laterally relative to said support surface.

18. The cutting assembly of claim 12, comprising:
a feed guide including a foot portion which comprises:
a bottom shelf;
a top shelf extending substantially parallel to said bottom shelf to define a gap between said top shelf and said bottom shelf; and,
wherein said sheet material may be fed through said gap between said top shelf and bottom shelf.

19. The cutting assembly of claim 18, wherein said feed guide includes a clamping mechanism that may be tightened to prevent said feed guide from sliding relative to said support section.

20. The cutting assembly of claim 12, further comprising:
at least one clip, wherein said clip is mountable to said front roller to secure a leading edge of said sheet material to said front roller.
